(19) United States
(12) Patent Application Publication
(10) Pub. No.: US 2006/0026172 A1
(43) Pub. Date: Feb. 2, 2006

(54) Media data storage device capable of determining whether requested media data is reproducible and transmission method thereof

(76) Inventor: Ui-cheol Roh, Suwon-si (KR)

Correspondence Address: STANZIONE & KIM, LLP, 919 18TH STREET, N.W., SUITE 440, WASHINGTON, DC, 20006, US

(21) Appl. No.: 11/181,750

(22) Filed: Jul. 15, 2005

(30) Foreign Application Priority Data
Jul. 16, 2004 (KR) 2004-55608

(51) Int. Cl. G06F 17/30

(52) U.S. Cl. 707/10

(57) ABSTRACT

A media data storage device having an interface to communicate data with an external electronic device comprises a first memory to store at least one media data object, a second memory to store predetermined reproducibility information including whether the at least one media data object is reproducible in the external electronic device, and a controller to determine whether a requested media data object is reproducible in the external electronic device according to the predetermined reproducibility information when the external electronic device requests the media data object stored in the first memory and to transmit a result of the determination to the external electronic device when the requested media data object is not reproducible in the external electronic device.

### CROSS-REFERENCE TO RELATED APPLICATIONS

This application claims the benefit of Korean Patent Application No. 2004-55608, filed Jul. 16, 2004, in the Korean Intellectual Property Office, the disclosure of which is incorporated herein in its entirety by reference.

### BACKGROUND OF THE INVENTION

1. Field of the Invention

The present general inventive concept relates to a media data storage device and a transmission method thereof, and more particularly, to a media data storage device capable of determining whether to transmit a requested media data object according to a reproducibility of the requested media data object, and a determination transmission method.

2. Description of the Related Art

Media data objects are encoded as various formats including *.mpg, *.mp3, *.avi, *.midi, and *.asx. The various formats of the media data objects can be distinguished from each other by their file extension. To reproduce the media data objects, there is a need for an executable program that corresponds to each format of the media data objects.

Additionally, a CODEC (coder and decoder) is needed to reproduce a media data object. For example, if there is an executable program capable of reproducing an MPEG (moving picture experts group) file having an extension of *.mpg, the CODEC used to decode the MPEG file should be the same version as the version used to encode the MPEG file in order to reproduce the MPEG file.

Recently, media data objects have been used for movies, music, images, moving picture lectures, etc. Since the use of media data objects at high video quality has become more diversified, data storage sizes of these media data objects have increased. Further, use of the Internet has enabled downloading of media data objects from a specific server and sharing media data objects stored in a personal computer with unspecified users through a P2P (peer to peer) type program. An amount of time it takes to download a media data object typically depends on its data storage size.

In conventional systems, when a user transmits a request to download a media data object to a sever, the media data object is downloaded regardless of whether the user has a proper executable program to reproduce the requested media data object or whether the user has the same CODEC as used to encode the requested media data object. Thus, the user may not be able to recognize whether the media data object is reproducible in their computer until the download of the requested media data object is complete. If the downloaded media data object is not reproducible in the user's computer, time and resources spent to download the requested media data object are wasted. Additionally, the user is not able to reproduce the requested media data object.

The abovementioned problem is not limited to data transmission between a server and a client, or data transmission through the P2P program, but may also arise in a central controlling system for a plurality of electronic devices, a device such as a media data storage, a media data player, or other systems for sharing and transmitting media data objects.

### SUMMARY OF THE INVENTION

The present general inventive concept provides a media data storage device and a transmission method thereof that is capable of informing a user whether a media data object requested by the user is reproducible.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept are achieved by providing a media data storage device having an interface to communicate data with an external electronic device, comprising a first memory to store at least one media data object, a second memory to store predetermined reproducibility information including whether the at least one media data object is reproducible at the external electronic device, and a controller to determine whether a requested media data object is reproducible at the external electronic device according to the predetermined reproducibility information when the external electronic device requests the requested media data object stored in the first memory and to transmit a result of the determination to the external electronic device when the requested media data object is not reproducible at the external electronic device.

If the controller determines that the requested media data object is not reproducible at the external electronic device, the controller can transmit the requested media data object to the external electronic device when the external electronic device requests the media data object within a predetermined allowable period of time after the result of the determination is transmitted to the external electronic device.

The external electronic device may transmit the predetermined reproducibility information to the controller, and the controller controls the second memory to store the predetermined reproducibility information.

The predetermined reproducibility information may include information about a CODEC (coder and decoder) used at the external electronic device and/or information about a reproducible format of the external electronic device.

The media data storage device may further comprise a data transformer to transform a data format of the requested media data object. The controller can determine whether the requested media data object can be transformed by the data transformer to have the reproducible format of the external electronic device. The controller can control the data transformer to transform the requested media data object to have the reproducible format of the external electronic device when the requested media data object is transformable, and the controller can transmit the transformed media data object to the external electronic device.

The foregoing and/or other aspects and advantages of the present general inventive concept may also be achieved by providing a media data storage device comprising a memory to store at least one media data object and predetermined reproducibility information of the at least one media data object that is reproducible in a predetermined media data player, and a controller to determine whether a media data object stored in the memory and requested by a media data player is reproducible in the media data player according to the predetermined reproducibility information and to prevent the requested media data object from being transmitted to the media data player when the requested media data object is not reproducible in the media data player.

The foregoing and/or other aspects and advantages of the present general inventive concept may also be achieved by providing a media data storage device comprising a memory storing at least one media data object, and a controller to transmit information about a data format of a media data object requested by a media data player to the media data player, to receive a response about whether the requested media data object is reproducible in the media data player, and to prevent the requested media data object from being transmitted to the media data player when the controller receives a response that the requested media data object is not reproducible in the media data player.

The foregoing and/or other aspects and advantages of the present general inventive concept may also be achieved by providing a media data storage device comprising a memory to store at least one media data object, an input unit to receive a command to transmit a selected media data object to an external electronic device, and a controller to determine whether the selected media data object to be transmitted is reproducible at the external electronic device when the command is transmitted from the input unit.

The controller may not transmit the selected media data object to the external device and may instead transmit a result of the determination to the external electronic device when the selected media data object to be transmitted is not reproducible at the external electronic device. The result of the determination can be transmitted to the external electronic device as a message informing a user that the selected media data object is not reproducible at the external electronic device.

The memory can store predetermined reproducibility information including whether the at least one media data object is reproducible at the external electronic device, and the controller can determine whether the selected media data object is reproducible according to the predetermined reproducibility information.

The foregoing and/or other aspects and advantages of the present general inventive concept may also be achieved by providing a network system comprising a client and a server storing media data objects, wherein the server determines whether a requested media data object is reproducible at the client end when the client requests the media data object.

The server can prevent transmission of the requested media data object to the client and may instead transmit a result of the determination to the client when the requested media data object is not reproducible in the client. The result of the determination may be transmitted to the client as a message informing a user that the at least one media data object is not reproducible in the client.

The server can receive reproducibility information including whether the requested media data object is reproducible at the client end from the client, can store the reproducibility information, and can determine whether the requested media data object is reproducible according to the reproducibility information.

According to a selection made by a user through the server and/or the client, the server can nevertheless transmit the requested media data object to the client even when the server determines that the requested media data object is not reproducible in the client.

The foregoing and/or other aspects and advantages of the present general inventive concept may also be achieved by providing a method of transmitting media data objects, the method comprising selecting a media data object to be transmitted to an external electronic device, determining whether the selected media data object is reproducible at the external electronic device, and preventing the selected media data object from being transmitted to the external electronic device when the selected media data object is not reproducible at the external electronic device.

When selecting the media data object to be transmitted to the external electronic device, the selected media data object and the external electronic device can be selected according to request information from the external electronic device and/or selection information input by a user.

The operation of determining whether the selected media data object is reproducible at the external electronic device may comprise comparing reproducibility information including whether a media data object is reproducible at the external electronic device with data format information about the selected media data object to be transmitted.

The reproducibility information may include information about a CODEC (coder and decoder) used at the external electronic device and information about a reproducible format at the external electronic device.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a schematic block diagram of a media data storage device according to an embodiment of the present general inventive concept; and

FIG. 2 is a flowchart illustrating a method of transmitting media data objects according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept while referring to the figures.

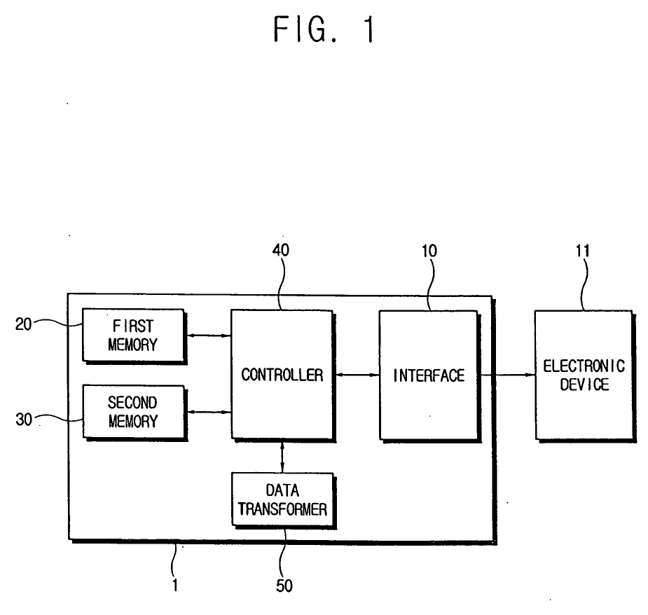

FIG. 1 is a schematic block diagram of a media data storage device according to an embodiment of the present general inventive concept.

As illustrated in FIG. 1, a media data storage device 1 comprises an interface 10, a first memory 20, a second memory 30, and a controller 40.

The interface 10 is used to communicate data with an external electronic device 11, and its configuration may vary according to connection types.

For example, if the external electronic device 11 is a client device on a network, the interface 10 can be realized by a wire or wireless LAN (local area network) card, a cable connector, a modem, etc. If the external electronic device 11 is a media data player, such as a camcorder, a DVD (digital video disk) player, an MP3 player, etc., the interface 11 can be realized by a USB (universal serial bus) communication module. The external device may be any device implemented in hardware, software, or a combination thereof that is capable of requesting a media data object transmission from a media data storage device.

The first memory 20 is used to store media data objects, and the second memory 30 is used to store predetermined reproducibility information that corresponds to the external electronic device 11. The predetermined reproducibility information may include a data format and a coding type. The predetermined reproducibility information about reproducibility of the media data objects at the external electronic device can be registered in a library. Alternatively, the media data objects and the predetermined reproducibility information can be stored in a single memory.

The predetermined reproducibility information may include information about types of data formats that are reproducible by the external electronic device 11 to receive the media data objects. That is, the predetermined reproducibility information includes information about the data formats of the media data objects that are reproducible by the external electronic device 11, information about the types of the reproducible CODEC (coder and decoder), and information about data storage sizes. Other types of information may also be included in the predetermined reproducibility information. If there is a plurality of external devices, the predetermined reproducibility information may be stored separately according to each of the plurality of external electronic devices 11. The predetermined reproducibility information may be device-specific.

A point of time when the second memory 30 stores the predetermined reproducibility information is related to the connection of the external electronic device 11.

For example, if a plurality of external electronic devices are communicatively connected in a public place, such as a hospital, a public office, an airport, etc., and are controlled by a central computer, the predetermined reproducibility information about each of the plurality of external electronic devices can be set when the system is designed. If a P2P communication protocol is used over the Internet, it may be difficult to store the predetermined reproducibility information about a connected client device prior to connection. When the client device requests a media data object, the second memory 30 requests and receives the predetermined reproducibility information from the client device and then stores the predetermined reproducibility information about the client device. Then, the stored predetermined reproducibility information is used by the controller 40 to determine reproducibility. The client device (i.e., the external electronic device 11) can transmit the predetermined reproducibility information to the controller 40 through the interface 10, and the controller 40 controls the second memory 30 to store the received predetermined reproducibility information.

The controller 40 controls storage of the media data objects, determines the coding type of the media data objects, and determines whether to transmit requested media data objects. The controller 40 may include a microcomputer having an operating function.

When the external electronic device 11 requests a media data object stored in the first memory 20, the controller 40 analyzes information about a data format, the coding type, and/or the data storage size of the requested media data object. Then, the controller 40 compares an analysis result with the predetermined reproducibility information stored in the second memory 30 corresponding to the external electronic device 11 requesting the media data object, thereby determining whether the requested media data object is reproducible at the external electronic device 11. If the controller 40 determines that the requested media data object is not reproducible at the external electronic device 11, the controller 40 can alternatively transmit the analysis result to the external electronic device 11. The controller can transmit the analysis result as a message to the external electronic device 11 informing a user associated therewith that the requested media data object is not reproducible at the external electronic device 11.

According to an embodiment of the present general inventive concept, the controller 40 determines whether to transmit the requested media data object according to whether the requested media data object is reproducible in order to prevent the requested media data object from being wastefully downloaded. If the requested media data object is not reproducible, the requested media data object may be transformed to have a reproducible format. This is a convenient feature for a user.

Accordingly, as illustrated in FIG. 1, the media data storage device 1 further comprises a data transformer 50 to transform the requested media data object to have the reproducible format of the external electronic device 11. The data transformer 50 may reduce the data storage size of the requested media data object by transforming its data format, transform the requested media data object to have the reproducible format of the external electronic device 11, and encode the requested media data object by the same coding type used by the external electronic device 11.

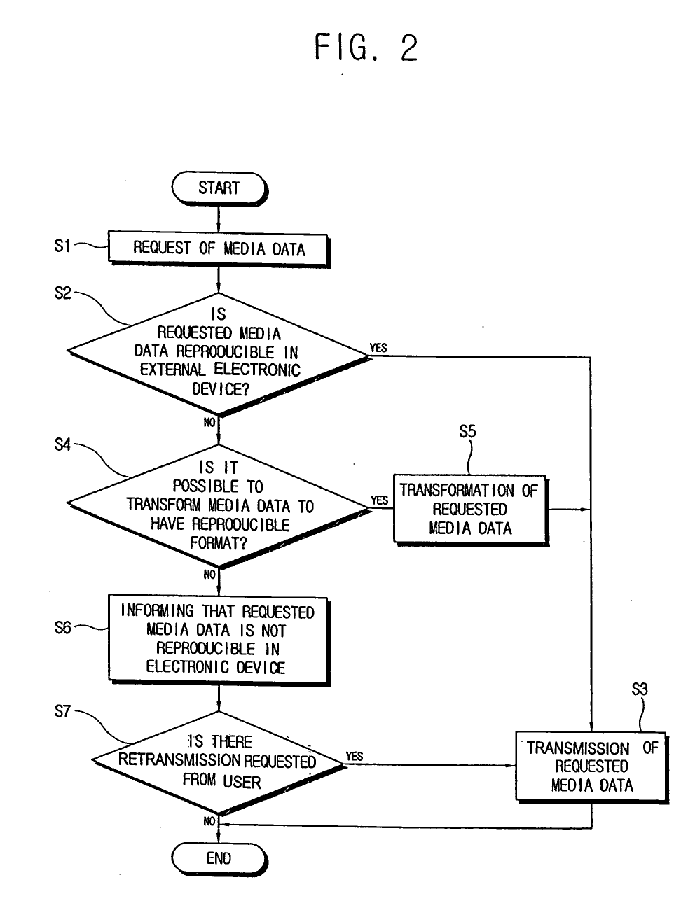

FIG. 2 is a flowchart illustrating a method of transmitting media data objects according to an embodiment of the present general inventive concept. Hereinbelow, a method of controlling the media data storage device 1, illustrated in FIG. 1, will be described with reference to FIG. 2.

At operation S1, a user selects a media data object to be transmitted to the external electronic device 11. If the user is a client on a network, the user can select a media data object by requesting it through the network. If the media data storage device 1 is used as a central controlling device, the media data storage device 1 further comprises an input unit to select the media data object to be transmitted and the external electronic device 11 to which the media data object is transmitted, so that the user can select the media data object through the input unit.

At operation S2, the controller 40 determines whether the requested media data object that is stored in the first memory 20 is reproducible in the external electronic device 11 associated with the user. The controller 40 analyzes information about the requested media data object and determines whether the analyzed information satisfies the predetermined reproducibility information stored in the second memory 30.

As a result of the determination that occurs at operation S2, when the requested media data object is reproducible at the external electronic device 11, the requested media data object is transmitted to the external electronic device 11. If the requested media data object is not reproducible at the external electronic device 11, the controller 40 determines whether the requested media data object can be transformed by the data transformer 50 to have the reproducible format for the external electronic device 11 at operation S4.

If the requested media data object is transformable, the controller 40 controls the data transformer 50 to transform the requested media data object to have the reproducible format of the external electronic device 11 at operation S5. The controller, at operation S3, then transmits the transformed media data object to the external electronic device 11. If the requested media data object is not transformable, the controller 40, at operation S6, transmits a message informing the user that the requested media data object is not reproducible in the external electronic device 11 associated with the user.

The message is transmitted to the external electronic device 11 through the interface 10 when a requester is a client on the network, or transmitted to a display device (not shown) accompanied with the media data storage device 1 when the requester belongs to the media data storage device 1.

At operation S7, if the user requests the media data object within an allowable period of time after the message is transmitted to the user, the controller 40, at operation S3, transmits the requested media data object to the external electronic device 11 associated with the user even though the controller 40 has determined that the requested media data object is not reproducible at the external electronic device 11.

If the same requested media data object is later requested to be transmitted to the external electronic device 11, it may be advantageous to be able to avoid repetitive determinations of reproducibility of the requested media data object. To avoid the repetitive determinations, the controller 40 can store determination information about the reproducibility of the requested media data object or the transformed media data object in a memory.

The media data storage device according to an embodiment of the present general inventive concept can be applied to a network system comprising a server and a client connected to the server through the network. Alternatively, the media data storage device according to an embodiment of the present general inventive concept may be applied to an external electronic device, such as a personal computer or the like, a media data player such as, for example, a camcorder, a displayer, etc. A request and a command to transmit data are generated from the media data storage device 1 or the external electronic device 11.

In another embodiment of the present general inventive concept, the media data storage device 1 can store media data objects therein and receive the predetermined reproducibility information of a requested media data object from the external electronic device 11, thereby determining whether the requested media data object is reproducible at the external electronic device 11. Alternatively, information about a data format, a coding type, and a data storage size of the requested media data object may be transmitted from the media data storage device 1 to the external electronic device 11 requesting the media data object, and then the external electronic device 11 may determine the reproducibility of the requested media data object and transmit a result of the determination to the media data storage device, thereby determining whether the requested media data object is transmittable to the external electronic device. Thus, a process and a time to store the predetermined reproducibility information, and the device and the method of determining the reproducibility of media data objects may vary as necessary.

As described above, the present general inventive concept provides a media data storage device and a transmission method thereof, in which media data objects are prevented from being wastefully transmitted and are transformed to have a reproducible format, thereby facilitating access to reproducible media data objects.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A media data storage device having an interface to communicate data with an external electronic device, comprising:
a first memory to store at least one media data object;
a second memory to store predetermined reproducibility information including whether the at least one media data object is reproducible in the external electronic device; and
a controller to determine whether a requested media data object is reproducible in the external electronic device according to the predetermined reproducibility information when the external electronic device requests the media data object stored in the first memory, and to transmit a result of the determination to the external electronic device when the requested media data object is not reproducible in the external electronic device.

2. The media data storage device according to claim 1, wherein the controller transmits the requested media data object to the external electronic device when the external electronic device requests the media data object within a predetermined allowable period of time after the result of the determination is transmitted to the external electronic device.

3. The media data storage device according to claim 1, wherein the external electronic device transmits the predetermined reproducibility information to the controller, and the controller controls the second memory to store the predetermined reproducibility information.

4. The media data storage device according to claim 1, wherein the predetermined reproducibility information includes at least one of information about a CODEC used in the external electronic device and information about a reproducible format of the external electronic device.

5. The media data storage device according to claim 3, wherein the predetermined reproducibility information includes at least one of information about a CODEC used in the external electronic device and information about a reproducible format of the external electronic device.

6. The media data storage device according to claim 1, further comprising a data transformer to transform a data format of the requested media data object to a reproducible format of the external electronic device, wherein the controller determines whether the requested media data object can be transformed by the data transformer to have the reproducible format of the external electronic device, controls the data transformer to transform the requested media data object to have the reproducible format of the external electronic device if the requested media data object is transformable, and transmits the transformed media data object to the external electronic device.

7. The media data storage device according to claim 1, wherein the second memory further stores predetermined reproducibility information associated with a plurality of external electronic devices including whether the at least one media data object is reproducible in each of the plurality of external electronic devices.

8. The media data storage device according to claim 1, wherein the controller controls the second memory to store predetermined reproducibility information including whether the at least one media data object is reproducible in the external electronic device at a time that the external electronic device is connected to the controller through an interface.

9. The media data storage device according to claim 1, wherein the controller stores the result of the determination such that the determination for the requested media data object need not be repeated at a later time.

10. A media data storage device comprising:
a memory to store at least one media data object and predetermined reproducibility information of the at least one media data object reproducible in a predetermined media data player; and
a controller to determine whether a media data object stored in the memory and requested by a media data player is reproducible in the media data player according to the predetermined reproducibility information, and to prevent the requested media data object from being transmitted to the media data player when the requested media data object is not reproducible in the media data player.

11. The media data storage device according to claim 10, wherein the controller transmits data instructing that the requested media data object is not reproducible if the controller determines from the predetermined reproducibility information that the requested media data object is not reproducible at the requesting media data player.

12. The media data storage device according to claim 10, further comprising:
a data transformer to transform a data format of the requested media data object to a reproducible format of the requesting media data player if the controller determines from stored predetermined reproducibility information associated with the requesting media data player that the requested media data object is not reproducible, and then the controller transmits the transformed reproducible data format.

13. A media data storage device comprising:
a memory to store at least one media data object; and
a controller to transmit information about a data format of a media data object requested by a media data player to the media data player, to receive a response about whether the requested media data object is reproducible in the media data player, and to prevent the requested media data object from being transmitted to the media data player when the controller receives a response that the requested media data object is not reproducible.

14. A media data storage device comprising:
a memory to store a plurality of media data objects;
an input unit to receive a command to transmit at least one of the media data objects to an external electronic device; and
a controller to determine whether the at least one media data object to be transmitted is reproducible in the external electronic device when the command is transmitted from the input unit.

15. The media data storage device according to claim 14, wherein the controller does not transmit the at least one media data object and transmits a result of the determination to the external electronic device when the at least one media data object to be transmitted is not reproducible in the external electronic device.

16. The media data storage device according to claim 14, wherein the memory stores predetermined reproducibility information including whether the plurality of media data objects are reproducible in the external electronic device, and
the controller determines whether the at least one media data object is reproducible according to the predetermined reproducibility information.

17. The media data storage device according to claim 14, wherein the controller stores a result of the determination for the at least one media data object such that the determination for the at least one media data object need not be repeated at a later time.

18. A network system comprising a client and a server storing media data objects, wherein the server determines whether a requested media data object is reproducible in the client when the client requests the media data object.

19. The network system according to claim 18, wherein the server does not transmit the requested media data object and transmits a result of the determination to the client when the requested media data object is not reproducible in the client.

20. The network system according to claim 18, wherein the server receives from the client and stores information about reproducibility of the requested media data object including whether the requested media data object is reproducible in the client, and determines whether the requested media data object is reproducible according to the reproducibility information.

21. The network system according to claim 18, wherein the server transmits the requested media data object to the client according to a selection made by a user through at least one of the server and the client even when the controller determines that the requested media data object is not reproducible in the client.

22. A method of transmitting media data objects, the method comprising:
selecting a media data object to be transmitted and an external electronic device to receive the selected media data object;
determining whether the selected media data object is reproducible in the external electronic device; and
preventing the selected media data object from being transmitted to the external electronic device when the selected media data object is not reproducible in the external electronic device.

23. The method according to claim 22, wherein selecting the media data object and the external electronic device further comprises selecting the media data object and the external electronic device according to one of a request information from the external electronic device and a selection information inputted by a user.

24. The method according to claim 22, wherein determining whether the selected media data object is reproducible in the external electronic device comprises comparing reproducibility information including whether media data objects are reproducible in the external electronic device with data format information about the selected media data object.

25. The method according to claim 24, wherein the reproducibility information includes information about a CODEC used in the external electronic device and information about a reproducible format in the external electronic device.

26. A method of transmitting media data objects, the method comprising:
storing a plurality of media data objects in a first memory and predetermined reproducibility information associated with one or more external electronic devices in a second memory;
receiving a request for at least one media data object from an external electronic device;
determining whether the at least one media data object requested is reproducible at the external electronic device end; and
transmitting the at least one media data object to the external electronic device if the at least one media data object is reproducible at the external electronic device end.

27. The method according to claim 26, further comprising:
if the at least one media data object is not reproducible at the external electronic device end, providing a user an option to request transmission of the at least one media data object even if the at least one media data object is not reproducible at the external electronic device end and transmitting the at least one media data object to the external electronic device.

28. The method according to claim 26, further comprising:
if the at least one media data object is not reproducible at the external electronic device end, determining a reproducible format of the external electronic device and transforming a data format of the at least one media data object to the reproducible format and transmitting the at least one media data object in the reproducible format to the external electronic device.

29. The method according to claim 26, further comprising:
if the at least one media object is not reproducible at the external electronic device end, transmitting a message to the external electronic device to notify a user that the at least one media data object is not reproducible at the external electronic device end.

30. The method according to claim 26, wherein the determining whether the at least one media data object is reproducible at the external electronic device end further comprises accessing predetermined reproducibility information associated with the external electronic device from the second memory and comparing the predetermined reproducibility information associated with the external electronic device with information about the at least one media data object.

31. The method according to claim 30, wherein the predetermined reproducibility information comprises at least one of a reproducible format of the external electronic device, an encoder/decoder version of the external electronic device, and a data storage size of the external electronic device.

32. A method of transmitting media data objects to one of a plurality of external electronic devices, the method comprising:
receiving a request for at least one media data object from an external electronic device;
receiving predetermined reproducibility information associated with the external electronic device from the external electronic device and storing the predetermined reproducibility information associated with the external electronic device in the memory;
determining whether the at least one media data object is reproducible at the external electronic device end;
transmitting the at least one media data object to the external electronic device if the at least one media data object is reproducible at the external electronic device end; and
if the at least one media data object is not reproducible, transmitting a message informing the external electronic device that the at least one media data object is not reproducible at the external electronic device end.
